(19) United States
(12) Patent Application Publication
(10) Pub. No.: US 2020/0001182 A1
(43) Pub. Date: Jan. 2, 2020

(54) DEVICE AND METHOD FOR PROVIDING A GAME BASED ON A LESSON PATH ON A KNOWLEDGE MAP

(71) Applicant: SCAPEFLOW, INC., Incheon (KR)

(72) Inventor: Mookwang JOUNG, New York (US)

(21) Appl. No.: 16/488,497

(22) PCT Filed: Feb. 22, 2018
(86) PCT No.: PCT/KR2018/002190

§ 371 Date: Aug. 23, 2019

(30) Foreign Application Priority Data
Feb. 24, 2017 (KR) 10-2017-0024536

(51) Int. Cl. A63F 13/5378; A63F 13/69

(52) U.S. Cl. CPC A63F 13/5378; A63F 13/69

(57) ABSTRACT

Provided is a method for providing a game service which includes constructing a visual knowledge map including coordinate points which correspond to one or more learning items; providing, in response to a service target user, a lesson path which includes one or more first points on the visual knowledge map and a second point, a next step of the first point and corresponds to a learning goal to a terminal to which the user is connected; providing a reward item to the user when the user clears the first point; and determining whether to provide a service of the second point according to a condition of the reward item if the user enters the second point.

### TECHNICAL FIELD

The present invention relates to a device and a method for providing a game service. More particularly, the present invention relates to a device and a method for providing a game service based on a lesson path on a knowledge map.

### BACKGROUND

Recently, based on the development of the Internet and network technology, various knowledge information exchanges between users are being actively performed. In particular, the World Wide Web has an abundance of informational materials that make up a large part of human knowledge and has the advantage of being easily accessible through the Internet.

In particular, learning plans have been proposed for learning from this World Wide Web by quickly finding high quality content that satisfies specific learning goals and preferences of individual users.

However, the current World Wide Web search engines have a drawback of inefficiency in learning plans. This is because the user can find the content they want only after visiting various websites in search results. In particular, even though contents used for education or employee training in schools or businesses are usually stable knowledge information with little change, and the same contents are repeatedly used over time, the aforementioned situation is produced. This is problematic.

In order to solve this problem, there have been proposed various learning plans for collecting, properly processing, and providing information on the Internet, but they are not very effective.

In particular, while learning plans based on a computer which shares a visual display interface through a computer network have been proposed, it is very difficult to induce interest and concentration of the user.

### SUMMARY

The present invention has been proposed to solve the aforementioned problems. An object of the present invention is to provide a device and a method for providing a game service which can interest and concentration of a user, comprising constructing a visual knowledge map based on collaborative learning and providing game plays using lesson paths on the knowledge map associated with learning objectives, thereby providing visualized learning information on the World Wide Web.

An aspect of the present invention, there is provided a method for providing a game service comprising: constructing a visual knowledge map including coordinate points which correspond to one or more learning items; providing, in response to a service target user, a lesson path which includes one or more first points on the visual knowledge map and a second point, a next step of the first point and corresponds to a learning goal to a terminal to which the user is connected; providing a reward item to the user when the user clears the first point; and determining whether to provide a service of the second point according to a condition of the reward item if the user enters the second point.

Another aspect of the present invention, there is provided a device for providing a game service comprising: a visual knowledge map-constructing unit configured to construct a visual knowledge map including coordinate points which correspond to one or more learning items; a lesson path-generating unit configured to provide, in response to a service target user, a lesson path which includes one or more first points of the visual knowledge map and a second point, a next step of the first point and corresponds to a learning goal to a terminal to which a user is connected; and a game information management unit configured to provide a reward item to the user when the user clears the first point and determine whether to provide a service of the second point according to a condition of the reward item if the user enters the second point.

The method according to the present invention can be embodied as a computer-readable recording medium in which a program for executing in a computer is recorded.

According to the present invention, it can be provided a device and a method for providing a game service which is able to induce interest and concentration of a user and guide in an efficient learning method, by constructing a visual knowledge map based on collaborative learning and providing reward items using lesson paths on the knowledge map associated with learning objectives and stepwise game plays according to the conditions of the reward items, thereby providing visualized learning information on the World Wide Web.

### BRIEF DESCRIPTION OF THE DRAWINGS

FIG. 1 is a view schematically showing an entire system according to an embodiment of the present invention.

FIG. 2 is a block diagram which more specifically describes the game service providing device according to an embodiment of the present invention.

FIGS. 3 and 4 are flowcharts illustrating a method for providing a game service according to an embodiment of the present invention.

FIGS. 5 to 8 are schematic diagrams illustrating a graphic interface of a learning game service based on a lesson path according to an embodiment of the present invention.

FIGS. 9 to 10 are conceptual diagrams illustrating a key acquisition and clearing process in a game service according to an embodiment of the present invention.

### DETAILED DESCRIPTION OF THE INVENTION

The following description merely illustrates the principles of the invention. Therefore, the skilled person in the art can embody the principles of the present invention and invent various devices that fall within the spirit and scope of the present invention even though they are not explicitly described or shown herein. Furthermore, it should be noted that all of conditional terms and embodiments listed herein are in principle intended to better understand the concept of the invention and are not to be limited to the specifically listed embodiments and conditions.

Further, it is to be understood that all of detailed descriptions, including the principles, aspects, and embodiments of the present invention, as well as listing specific embodiments, are intended to encompass structural and functional equivalents of these matters. In addition, it is to be understood that these equivalents are intended to include not only equivalents now known, but also equivalents to be developed in the future, that is, all devices invented to perform the same function regardless of structure.

Thus, for example, the block diagrams shown herein should be understood to represent a conceptual view of example circuitry embodying the principles of the invention. Similarly, all of flowcharts, state transitions, pseudo-codes and the like should be understood to represent various processes performed by a computer or processor, whether or not they are substantially presented on a computer readable medium and the computer or processor is clearly shown.

The functionality of various elements shown in the figures including functional blocks represented as a processor or similar concept can be provided by using dedicated hardware as well as hardware capable of executing appropriate software. If it is provided by a processor, the functionality may be provided by a single dedicated processor, a single shared processor or a plurality of individual processors, some of which may be shared.

Also, the terms used herein with respect to processor, control or similar concept should not be interpreted by exclusively citing only hardware capable of executing software, but such terms should be understood to implicitly include, without limitation, digital signal processor (DSP) hardware, ROM for storing software, RAM, and non-volatile memory. It may also include known other hardware.

In the claims of this specification, components expressed as means for performing the functions described in the detailed description are intended to include all of methods which perform functions including all types of software including, for example, any combination of circuit elements performing such functions or firmware/microcode, etc., and these components are coupled to appropriate circuitry for executing the software to perform such functions. It should be noted that the present invention, as defined by these claims, is equivalent to what is understood from this specification, as any means capable of providing such functionality, as the functionalities provided by various enumerated means are combined, and in any manner required by the claims.

The aforementioned objects, features, and advantages will be more apparent from the following detailed description in conjunction with the accompanying drawings, and the skilled person in the art may easily implement the technical idea of the present invention therefrom. Further, when it is determined that the detailed description of known technologies related to the present invention may unnecessarily obscure the gist of the present invention, the detailed description thereof will be omitted.

Hereinafter, exemplary embodiments of the present invention will be described in detail with reference to the accompanying drawings.

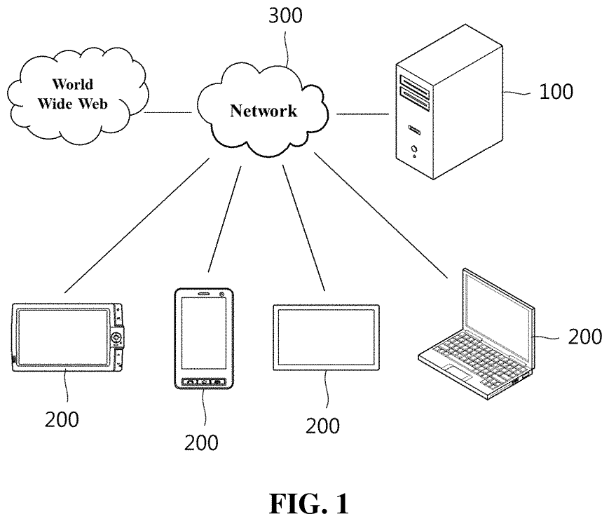

FIG. 1 is a view schematically showing an entire system according to an embodiment of the present invention.

Referring to FIG. 1, the entire system for providing a game service based on a lesson path according to an embodiment of the present invention comprises a game service providing device 100, at least one terminal 200, and a network 300.

Firstly, the at least one terminal 200 may be one terminal or a plurality of terminals and different terminals 200 may be connected to the game service providing device 100 through the network 300 to perform inter-communication.

The communication provided by the network 300 may be realized through all types of wired/wireless networks including local area network (LAN), wide area network (WAN), value added network (VAN), personal area network (PAN), mobile radio-communication network or satellite communication network, and an inter-communicational network may be provided by a communication method such as mobile communication network, UPnP (Universal Plug and Play) or WiFi.

The at least one terminal 200 may be a stationary terminal or a portable mobile terminal. As one or more terminals 200, a navigation, a smart phone, a mobile phone, a computer, a laptop computer, a digital broadcasting terminal, a personal digital assistant (PDA), a portable multi-media player (PMP), a MID (Mobile Internet Device), Tablet PC (Tablet PC) and the like can be exemplified.

Any one terminal 200 may constitute communication via the network 300 with other terminals 200 through the game service providing device 100. In addition, the terminals 200 connected to the network 300 may cooperatively share various contents including learning and game contents.

To this end, the game service providing device 100 may relay communication between servers which provide network services. In addition, the game service providing device 100 may remotely or directly control to provide a game service according to an embodiment of the present invention through each terminal 200.

As such, each of one or more terminals 200 is connected to the game service providing device 100 via the network 300, and then the game service providing device 100 processes information about the in-game state of each terminal 200 to provide a game service such as a single player game or an online game. In addition, the game service providing device 100 may share various learning related information or transmit a message in association with an online communication service.

That is, referring to FIG. 1, the game service providing device 100 may be connected to the World Wide Web through the network 300 to construct a database for providing learning information and game services.

Further, the game service providing device 100 may collect learning information which corresponds to a learning goal or lesson plan by using the database thus constructed; process relationship information according to the collected learning information; and construct a visual knowledge map based on to a layering process. The visual knowledge map may comprise a movable map tile based on coordinate information visualized in two or three dimensions. Here, a specific point in the coordinate information may correspond to a respective learning item.

As such, the game service providing device 100 may generate one or more lesson paths by sequentially connecting these points and learning items corresponding to specific learning goals.

According to an embodiment of the present invention, the game service providing device 100 may also provide a game service based on such a lesson path to a user's terminal 200 to which the user is connected.

To this end, in response to a service target user, the game service providing device 100 may provide a lesson path including one or more points from a first point to a second point on the visual knowledge map; judge one or more key conditions required for entry from the first point to the second point; and determine an entry to the second point according to whether the key condition is satisfied. Here, the key condition may be a condition for achieving a certain skill or achievement (or clearing a corresponding goal), and a key item may be provided as a reward item when a clear is achieved. The reward item may further include a badge item, a character item, a certain game score or master level, a star rating, and the like.

For example, these points may respectively correspond to a specific learning goal, and to acquire a learning goal corresponding to the second point, achievement of two or more learning goals may be premised. However, if a learning goal premised for a particular user is unilaterally provided to the user, the user's concentration and interest may be lowered.

To solve this problem, in an embodiment of the present invention, according to whether the first points corresponding to learning objectives premised for the second points are cleared or mastered, each key item may be provide to the user. Further, the present invention provides a game service in a manner in which any second point is opened according to any combination of key items, thereby inducing interest of the user and inspiring concentration and achievement.

By using this configuration, the user can freely explore each point, collect key items and move on to further learning levels (e.g., next game level or stage) while being provided with a game service based on a lesson path. In addition, the user can acquire a corresponding reward item. Accordingly, any learning can be very interestingly performed through such game service based on a visual knowledge map.

To this end, more particularly, the game service providing device 100 according to an embodiment of the present invention may construct a visual knowledge map including coordinate points which correspond to one or more learning items; provide, in response to a service target user, a lesson path which includes one or more first points on the visual knowledge map and a second point, a next step of the first point and corresponds to a learning goal to a terminal to which the user is connected; provide a reward item to the user when the user clears the first point; and determine whether to provide a service of the second point according to a condition of the reward item if the user enters the second point.

A learning item on one or more first points may be a learning item premised for a learning item in the second point, and the reward item includes a plurality of first key items corresponding to one or more first points. The game service providing device 100 may determine whether a key condition is satisfied depending on whether all the plurality of first key items are acquired. If said key condition is not satisfied, the game service providing device 100 may provide other information related to a key required to enter the second point.

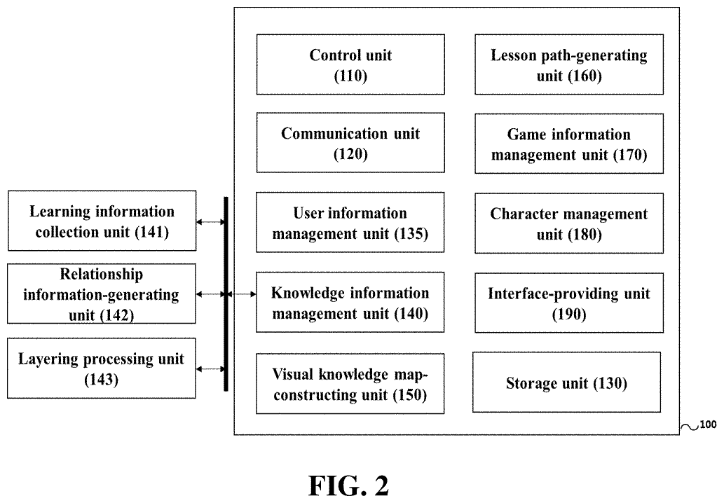

FIG. 2 is a block diagram which more specifically describes the game service providing device according to an embodiment of the present invention.

Referring to FIG. 2, the game service providing device 100 according to an embodiment of the present invention may comprise a control unit 110, a communication unit 120, a storage unit 130, a user information management unit 135, a knowledge information management unit 140, a visual knowledge map-constructing unit 150, a lesson path-generating unit 160, a game information management unit 170, a character management unit 180, and an interface-providing unit 190.

The control unit 110 usually controls the overall operation of the game service providing device 100. For example, the control unit 110 may control the overall communication between related modules and perform various data processing such that it can process various information including learning information collection, user information management, layering processing, relationship information generation, visual knowledge map construction, lesson path generation, game information management, character management, interface provision and management, data communication, message transmission and SNS connection. Although FIG. 2 shows the control unit 110 as being separately present for controlling respective components, all or part of functions of the control unit 110 may be distributed and synchronized in each component even if the control unit 110 is not included.

The communication unit 120 may be connected to the terminal 200 through the network 300, and may perform data transmission/reception of game service information for the terminals 200. The communication unit 110 in a wireless form may comprise one or more modules which enable wireless communication between the terminal 200 and the server 100 or between the terminal 200 and a network on a communication network 300 where the terminal 200 is located. For example, the communication unit 120 may comprise a mobile communication module, a wired internet module, a wireless internet module, a short range communication module and the like.

The mobile communication module receives and transmits a wireless signal from/to at least one of a base station, an external terminal and a server on a mobile communication network. The wireless signal may include various types of data according to transmission and reception of a voice call signal, a video call signal, or a text/multimedia message. The wireless Internet module refers to a module for wireless Internet access, and may be built in or external to the terminal 200. Wireless Internet technologies may include WLAN (Wireless LAN; Wi-Fi), Wibro (Wireless Broadband), Wimax (World Interoperability for Microwave Access), HSDPA (High Speed Downlink Packet Access) and the like. The short range communication module may mean a module for short range communication. Short range communication technologies may include Bluetooth, RFID (Radio Frequency Identification), IrDA (Infrared Data Association), UWB (Ultra Wideband), ZigBee and the like.

The user information management unit 135 may register and manage user information in response to users of the game service according to an embodiment of the present invention. The user information may include the user's personal information, and each user may have respective identification information corresponding to a teacher and a learner and relationship information with other users. The user information may be newly registered, updated and managed according to a user information registration or update request received from the terminal 200. Furthermore, all or part of the user information may be transmitted to the terminal 200 at the request of the terminal 200.

In addition, the user information management unit 135 may classify and manage the user information according to a learner and a teacher. The user information may include, for example, at least one of a learner's date of birth, gender, name, mobile phone number, address and profile information, as well as learning goal information for said learner and proficiency information for said learning goal. Furthermore, the user information may include, for example, at least one of a teacher's date of birth, gender, name, mobile phone number, address and profile information, as well as learner list information for said teacher.

The storage unit 130 may store in a predetermined storage space control data for the operation of the control unit 110, as well as user information, collection information, relationship information, knowledge information, visual knowledge map construction information, lesson path information, game information, other information, character information, game information for providing an interface, etc. which are managed in respective components.

In particular, according to an embodiment of the present invention, the storage unit 130 may include information about a learning goal, a lesson path and a learning item corresponding to a user previously registered in the user information, and a game information database region corresponding to said lesson path and learning item information. The game information database region may store game play information including game items acquired for a game challenged by the user on the lesson path and achievements.

The knowledge information management unit 140 collects learning information required to construct the visual knowledge map on the World Wide Web, layers the collected learning information, processes it, and then provides basic information to construct a knowledge map in the visual knowledge map-constructing unit 150.

By using the learning information thus layered, the knowledge information management unit 140 may also construct a visual knowledge map in which distances and coordinates for each learning item are determined according to the relationship information in the visual knowledge map-constructing unit 150.

To this end, the knowledge information management unit 140 may comprise a learning information collection unit 141, a relationship information-generating unit 142, and a layering processing unit 143.

The learning information collection unit 141 may collect text corpus information of each knowledge area required for constructing a knowledge map from the World Wide Web at desired time intervals or as necessary, and may classify the collected text corpus information according to each learning item. The text corpus information may be a sample set of languages extracted according to a learning goal, and may be obtained by morphological analysis from a web page according to the learning goal index. The obtained text corpus information may be classified according to each learning item.

The relationship information-generating unit 142 may calculate a degree of relationship between learning items based on the classified text corpus according to an ontology operation on the classified text corpus information, and may generate coordinate information on a knowledge map according to the degree of relationship.

For example, the learning item may include a set of concepts or topics in at least one subject area. Each concept may be associated with a text corpus, and the similarity or distance between each pair of two concepts may be calculated by comparing and analyzing the related text corpuses. This procedure can be achieved by executing a desired computerized command using a natural language processing technique such as multidimensional scaling or nonlinear mapping. Furthermore, the relationship between learning items may be updated according to user-item interaction data or information input by a user.

In addition, the relationship information-generating unit 142 may define a virtual high-dimensional semantic space based on a hyperlink structure on the World Wide Web related to vocabularies of the text corpus and/or documents included therein, and may generate relationship information by measuring a distance between the concepts therein, for example, as a Euclidean distance. The relationship information-generating unit 142 may also generate unique coordinates of individual learning items, as well as a group of connections and relationships therebetween.

The layering processing unit 143 may form a layered structure between items consisting of subject areas, subfields, concepts, contents and the like based on interconnected characteristic information for learning items (or lesson plans) provided from the relationship information-generating unit 142.

The visual knowledge map-constructing unit 150 may construct a visual knowledge map which is capable of being explored and visually recognized in the user's terminal 200 according to the learning information which is collected, associated with each other and layered in the knowledge information management unit 140.

According to an embodiment of the present invention, the visual knowledge map may include a two- or three-dimensional map; each coordinate may correspond to the coordinates of the learning items as described above, and a distance between the coordinates of the learning items and their mutual positions may be determined according to the relationship information and the layering information. Thus, the visual knowledge map can be constructed in various forms based on knowledge information on the World Wide Web.

For example, the visual knowledge map-constructing unit 150 may execute a desired computerized command in the control unit 110 for a dimension reduction method to maintain the maximum distance information, thereby reducing by one, two, or three spatial dimensions, followed by constructing a visualized or explored visual knowledge map. A result including a set of coordinates calculated in relation to concepts in one, two or three dimensional finite space may be stored in at least one database.

The visual knowledge map-constructing unit 150 may also convert coordinates or points into areas such as polygons, for example, through a planar/spatial division (tessellation) method such as Voronoi tiling. In this case, the coordinates of the vertices of each polygon may be stored in at least one database.

Also, the lesson path-generating unit 160 may generate a lesson path that sequentially connects each of learning items associated on the visual knowledge map in achieving a learning goal.

The lesson path may include respective points for acquiring one or more learning items, and the user may sequentially move to each stepwise point through the visual knowledge map provided from the game service providing device 100.

In particular, in an embodiment of the present invention, the lesson path-generating unit 160 may include path information which is previously determined by an expert of a lesson or learning item, otherwise produced or updated by a user's input according to a predetermined particular sequence.

The visual knowledge map-constructing unit may include a group of learning items, which are coupled through a sequence of directed weighted edges in the form of lines, arrows, etc. according to the relationship information, thereby forming a linear array, loop (closed loop), tree or graph.

The lesson path may be formed according to a certain degree of temporal or logical priority, and may be updated by a cooperative and self-regulating method according to user-item interaction accumulation data. Thus, the user may perform a exploration along the lesson path to acquire new knowledge or evaluate current knowledge. For example, the user may be assessed on his proficiency or master level by watching an image, reading a web page, or solving a problem at a particular point on the lesson path.

And, in order to maximize the effect and interest of such lesson path-based learning, the game information management unit 170 may perform a game activation for the lesson path, and may provide the game-activated lesson path to the user.

To achieve the game activation, the game information management unit 170 may assign a stepwise level to each point according to the difficulty level for each point on the lesson path. Then, the game item may be provided according to the activity and master degree in each point by the user. The game item may include, for example, a key item or badge item obtained in a locked box as the user masters each point.

In particular, in an embodiment of the present invention, the key item may be used as a precondition for entering another point. For example, when the user enters a new learning item on the lesson path, the game information management unit 170 may identify key item condition information for the second point corresponding to the learning item, and judge that the key item collected by the user satisfies the identified condition to determine whether to enter the second point. Thus, the user can check learning items related to key items that must be acquired as a precondition before entering the second point on the lesson path, and voluntarily perform prior learning to master them. As a result, the effect of learning can be improved by the game service using the feeling of achievement according to the present invention.

According to the game service provided by the game information management unit 170, the user may acquire various rewards as well as key items. For example, the user may obtain a badge item that is granted when the user completes a lesson path of a specific learning goal, and whether or not the badge item is held may also be used as an entry condition to a new point such as a key item.

The character management unit 180 may store and manage character information setting for each user. The character information may be displayed on a dashboard screen when the user logs in to the game service, and each character may be provided through various game plays such as mastering a particular learning objective, a particular area on the knowledge map, or a particular point on the lesson path, or completing a task assigned to the user. Thus, the user can continuously perform a learning activity for acquiring a desired character.

The interface-providing unit 190 may generate various graphical user interfaces (GUIs) for providing the visual knowledge map, moving two- or three-dimensional locations on the knowledge map, checking lesson paths and learning items, checking dashboards, using game services and providing indexes and provide it to the terminal 200 to which a user is connected.

The interface-providing unit 190 may transmit an interface to the terminal 200 using a wired/wireless network through a communication unit 120. The interface may be realized as a graphic object that is a playable form in the terminal 200 and may be displayed in various ways according to a user's input.

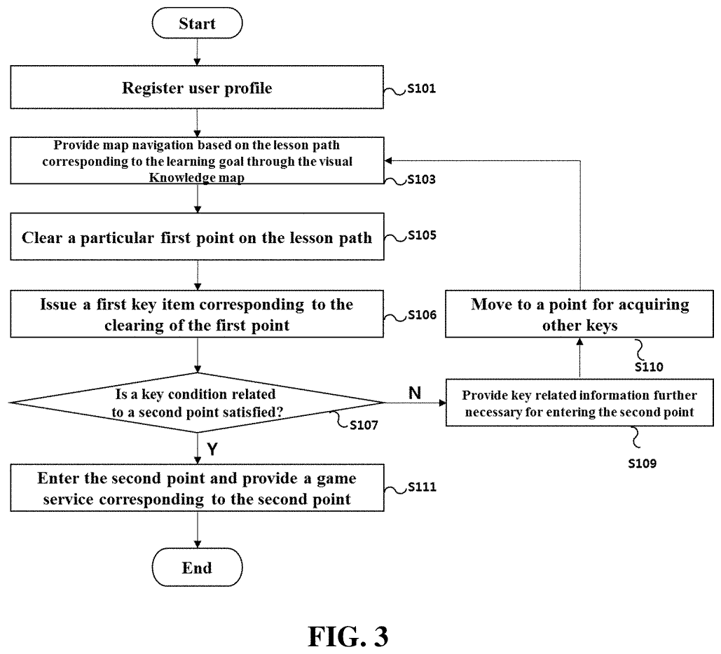

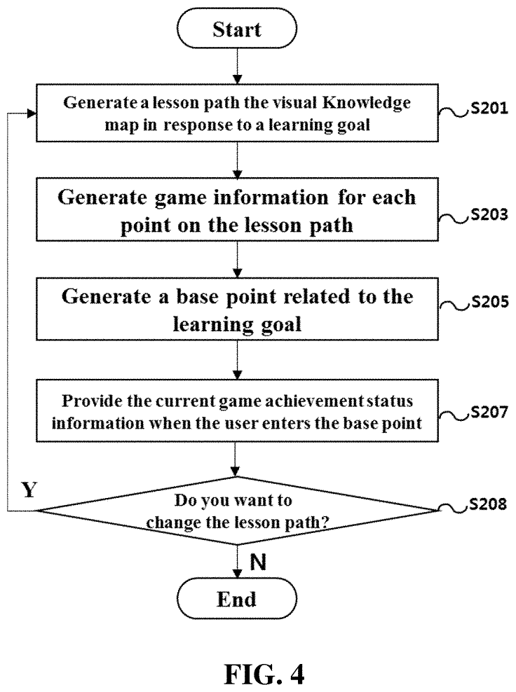

FIGS. 3 and 4 are flowcharts illustrating a method for providing a game service according to an embodiment of the present invention.

Referring to FIG. 3, firstly, the game service providing device 100 registers a user profile through the user information management unit 135 (S101).

According to the registered user profile or game play information of the user recorded in the storage unit 130, a learning goal corresponding to the user may be set, and learning items corresponding to the learning goal may be determined.

The game service providing device 100 provides map navigation based on a lesson path generated from the lesson path-generating unit 160 according to the learning goal, through the visual knowledge map constructed from the visual knowledge map-constructing unit 150 (S103). The map navigation may include one or more lesson paths and characteristic information of each path (for example, required time, difficulty level, score, etc.).

The game information management unit 170 generates the user's clear information for a particular first point on the lesson path, through the game activation of the lesson path (S105), and a first key item is issued as the first point is cleared (S106).

For example, whether a particular point is cleared may be determined according to a degree of mastering the entire learning goal or an increase in the proficiency of the learning item. In addition, the degree of mastering or the proficiency may be determined based on the user's viewing time of learning materials, web page scroll information, quiz answer rate information, and other feedback information. Thus, the game information management unit 170 may store and update information on whether a particular point on the lesson path is cleared for each user.

The game information management unit 170 may issue, for example, a first key item to the user as a reward for the cleared point. The user who cleared the first point may order the movement to the second point, which is the next step. Then, the game service providing device 100 determines whether a key condition related to the second point of the user who enters the second point is satisfied (S107).

Here, the key condition may correspond to a preceding learning item for understanding the learning item related to the second point. For example, in order to understand the learning item for the second point, it may be necessary to understand the learning item for the first point. Accordingly, the game service providing device 100 may request a first key item or a plurality of key items related to the first point for learning the second point.

If the key condition is satisfied, the game service providing device 100 may enter the second point and subsequently provide a game service corresponding to the second point (S111).

To the contrary, if the key condition is not satisfied, the game service providing device 100 provides key related information further necessary to enter the second point (S109).

The key related information may include, for example, coordinate information of other key items required for opening of the second point, learning item information corresponding to other key items, or image information such as color, size, and shape of key items.

Also, according to the user's input, the game service providing device 100 may provide a path movement to a point for acquiring other keys through the game information management unit 170 according to a user input (S110), and may perform map navigation again (S103).

Referring to FIG. 4, the game information management unit 170 may generate a base point on the lesson path according to an embodiment of the present invention, and may further provide the user's current state information when the user enters the base point.

To this end, firstly, the game service providing device 100 generates a lesson path on the visual knowledge map corresponding to the learning goal through the lesson path-generating unit 160 (S201), and generates game information for each point on the lesson path through the game information management unit 170 (S203).

The game information for each point may include information on game clear targets and reward items (key item, badge item, character item, etc.).

The game service providing devices 100 may also generate a base point related to the learning goal through the game information management unit 170 (S205).

Then, the game service providing device 100 provides the current game achievement state information when the user enters the base point (S207).

In an embodiment of the present invention, alternative lesson paths related to the subject learning goal or location and characteristic information of learning items may be provided in the form of a list and/or a map at the base point.

According to the configuration as described above, a base point may be generated for each subject or learning filed. In addition, when the user enters the subject base point during the movement along the lesson path, he can check the current game achievement state information including information on game clear targets and reward items (key item, badge item, character item, etc.), thereby performing intermediate check.

Thus, the user may modify his strategy for achieving the learning goal during learning based on the information provided in the base point. For example, the user can decide to proceed with learning along a new lesson path by selecting second paths or learning items which are recommended and provided by the system instead of the previously selected lesson path (S208).

The base point may be visualized on the knowledge map in the form of a building, a structure, a tent, a screen, a blackboard, or a wall.

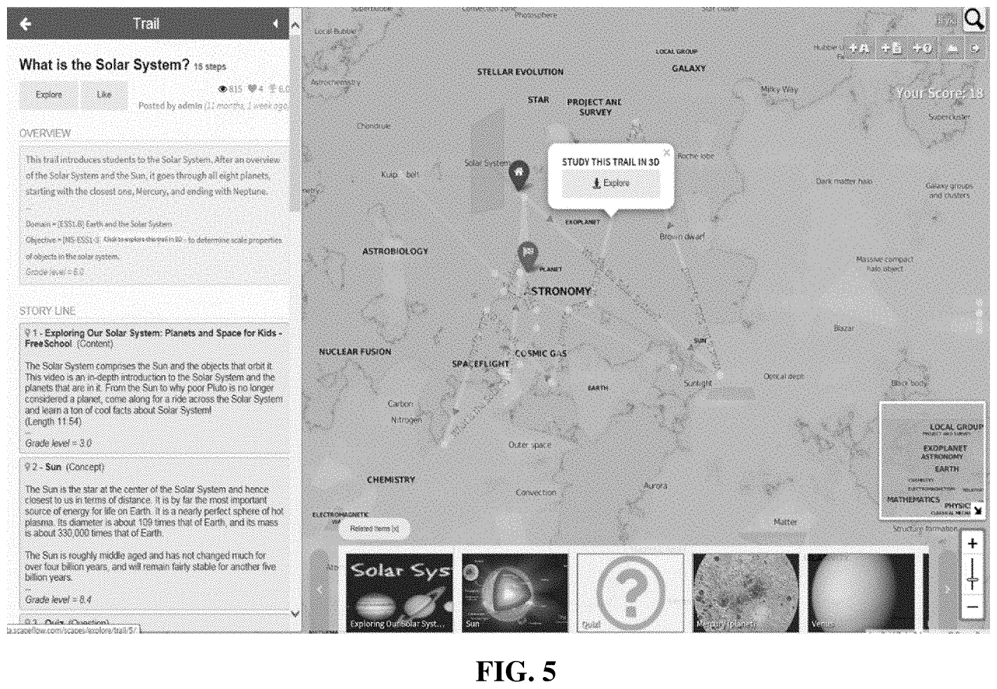

FIGS. 5 to 8 are schematic diagrams illustrating a graphic interface of a learning game service based on a lesson path according to an embodiment of the present invention.

Referring to FIG. 5, the visual knowledge map may include a virtual terrain realized as computer graphics. In addition, the visual knowledge map may include learning items and lesson paths (e.g., stepwise linking of the contents of the World Wide Web or textbook) on the map, and it may be constructed by reflecting the conceptual similarity and relationship between a learning item and a lesson path. Thus, the visual knowledge map may additionally provide a two- and three-dimensional visual display interface for exploring and navigating contents (e.g. zooming in/out, panning, etc.) as well as actual learning, thereby providing an immersive and smooth user interface.

Also, the knowledge map may include a two-, a three-, a four-dimensional landscape (including 1-dimensional time) or a plurality of such landscapes having a single global coordinate system, and similar learning items may be positioned closer to each other. As the user's input and interaction, the structure of the landscape may be dynamically changed over time.

Learning items and lesson paths can be collected in a crowdsourcing manner, and learners can add new items or lessons to the landscape of knowledge, or provide feedback (for example, ratings, reviews) about what they have used. According to an embodiment of the present invention, the game service providing device 100 may continuously or intermittently change (re-generate, update) the knowledge environment according to a desired computerized command, on the basis of inputs of a learner group and user-item interactions that occur during learning, and may select or extract recommended learning paths for achieving a given learning goal in a way that improves the overall user experience and learning efficacy.

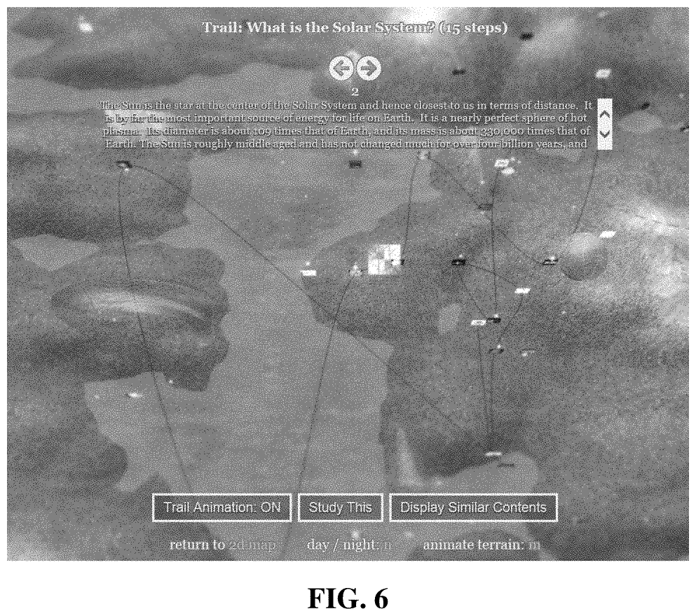

Referring to FIG. 6, the visual knowledge map may include a set which has a geometric region such as a polygon representing a subject, concept or topic, and a group of lesson paths represented by a plurality of lines or arrows drawn along the lesson path. The geometric region may include, for example, a plurality of learning items (such as contents, assessment questions) that may be represented as a point or a set of points.

The world of the knowledge map can be visualized as a landscape (land landscape, sea landscape, urban landscape, underground space, outer space, etc.) or any combination of these landscapes. The landscape of knowledge can be visualized to the user in the form of a tile map or a perspective view through a projection method including a tilted three-dimensional (or similar) map projection and/or a fly-through mode. Thus, the user can view or interact with the landscape using a virtual reality or augmented reality device (for example, a wearable headset, etc.) for an immersive learning experience.

Visual attributes of an item or lesson may include lines, polygons, coordinates, paths, heights, depths, environments, surface textures, shapes, icons, sizes, widths, distances, colors, brightness, and the like. For example, in an embodiment of the present invention, the game service providing device 100 allows a user to connect a plurality of learning items to create new lesson paths, and the width or color of these paths may be changed as their relative importance or efficacy measure may change over time.

Enriched semantic (ontology) relationships between items, between lessons and between items and lessons including subclass, superclass, similarity and hierarchy may be visualized by graphics in the form of lines, arrows, Venn diagrams, trees, and graphs on the landscape of knowledge. For example, lines between learning items may indicate a similarity relationship, and arrows between lessons may indicate a precondition (prior condition) relationship. Also, a key condition on the game service may be determined according to the precondition relationship.

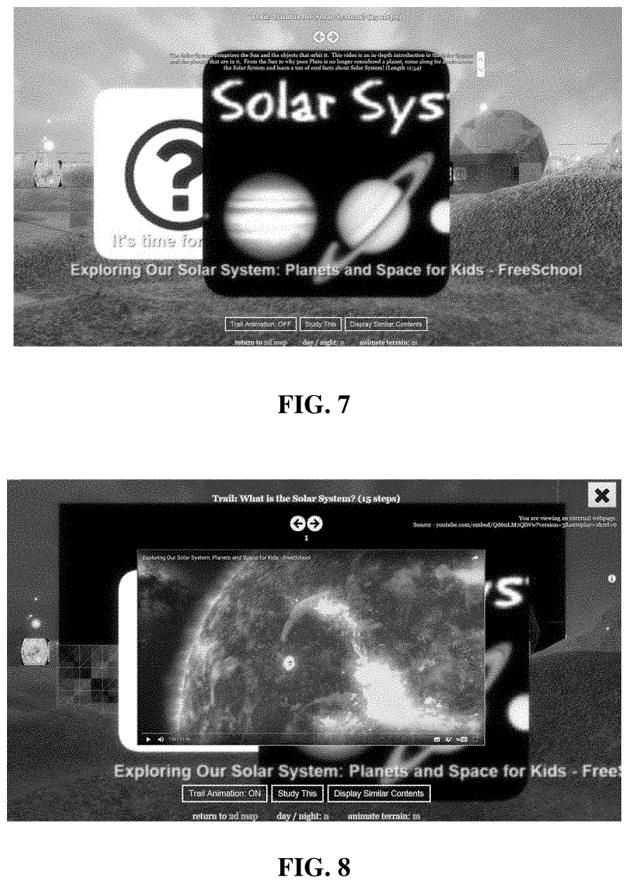

Referring to FIGS. 7 to 8, these figures illustrate contents provided to the user at each point along the lesson path. In this case, the user is provided with the lesson path for the solar system, and he can clear each point through the activity in each point (watching a video, reading a web page or solving a question).

In particular, at a specific point such as measuring the proficiency on the lesson path, when the user clears this point, a key item may be provided as a precondition for learning the second point.

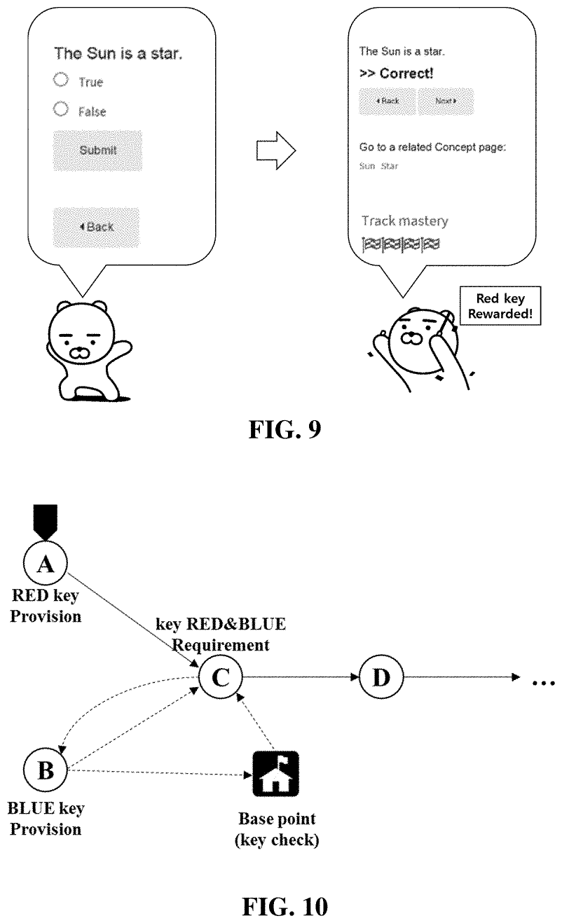

FIGS. 9 to 10 are conceptual diagrams illustrating a key acquisition and clearing process in a game service according to an embodiment of the present invention.

Referring to FIG. 9, at a particular point on the lesson path according to an embodiment of the present invention, it is possible to acquire a key item as a result of user activity (solving a question, etc.) related to a learning item. For example, as shown in FIG. 9, at a first point, the user may solve a question which is issued by a pre-registered character, and may master the first point according to a result of solving one or more questions. The game information management unit 170 may check whether the first point is cleared based on the master proficiency, and, if cleared, may provide a key item as a reward therefor. FIG. 9 shows that RED KEY is provided to the user.

In addition, as shown in FIG. 10, learning items in each point may be different from each other, such as A, B, C, and D. However, in order to learn the concept of C, learning of A and B may be premised as a precondition. Therefore, in this case, the user who cleared A and received the RED key may move to the point C on the lesson path, and both the RED key and the BLUE key may be required to enter the point C. Then, the user may be also provided with information on the point B for acquiring the BLUE key item. Then, the user will move to the point B to perform a learning activity and acquire the BLUE key item to open the point C.

As described above, the base point can provide the user's current game achievement state information. In particular, the user can check a degree of mastering each learning objective or learning item, key item acquisition status, badge item acquisition and the like. As a result, the effect of learning can be improved by the game service using the feeling of achievement.

The base point may be additionally provided with alternative lesson paths related to the subject learning goal and characteristic information of learning items, so that the user can modify a strategy (or lesson path) for achieving his learning goal.

The method according to the present invention as described above may be stored in a computer-readable recording medium as a program for execution on a computer. Examples of the computer-readable recording medium include ROM, RAM, CD-ROM, magnetic tapes, Floppy disks, optical data storages, and the like.

The computer-readable recording medium can be distributed in computer systems which are connected through a network, and computer readable codes may be stored and executed in such distributed form. In addition, functional programs, codes, and code segments for realizing the method can be easily inferred by programmers in the art to which the present invention belongs.

Although the present invention has been described by the preferred embodiments, the present invention is not limited to the specific embodiments described above, but the skilled person in the art to which the invention belongs can make various modifications on the present invention without departing from the spirit of the invention defined in the claims, and these modifications should not be individually understood from the technical spirit or prospect of the present invention.

1. A method for providing a game service, comprising:
constructing a visual knowledge map including coordinate points which correspond to one or more learning items;
providing, in response to a service target user, a lesson path which includes one or more first points on the visual knowledge map and a second point, a next step of the first point and corresponds to a learning goal to a terminal to which the user is connected;
providing a reward item to the user when the user clears the first point; and
determining whether to provide a service of the second point according to a condition of the reward item if the user enters the second point.

2. The method for providing a game service of claim 1 wherein a learning item in said one or more first points are a precondition for a learning item in said second first point.

3. The method for providing a game service of claim 1 wherein the reward item comprises a plurality of first key item which corresponds to one or more first points, and said determining whether to provide a service comprises determining whether a key condition is satisfied based on whether all key items are acquired.

4. The method for providing a game service of claim 3 further comprising providing other key related information if the key condition is not satisfied.

5. The method for providing a game service of claim 1 wherein said constructing a visual knowledge map further comprises:
generating game information for each point of the lesson path; and
generating a base point which corresponds to the learning goal.

6. The method for providing a game service of claim 5 further comprising providing the current game achievement state information related to said user and an alternative paths and learning items when said user enters the base point.

7. The method for providing a game service of claim 1 wherein said constructing a visual knowledge map further comprises:
collecting learning information including text corpus related to the learning item from the World Wide Web;
generating relationship information between the text corpus and learning item;
performing a layering processing of the learning information based on said relationship information; and
constructing the visual knowledge map in which a distance and a coordinate for each learning item are determined according to said relationship information using said layered learning information.

8. A device for providing a game service comprising:
a visual knowledge map-constructing unit configured to construct a visual knowledge map including coordinate points which correspond to one or more learning items;
a lesson path-generating unit configured to provide, in response to a service target user, a lesson path which includes one or more first points of the visual knowledge map and a second point, a next step of the first point and corresponds to a learning goal to a terminal to which a user is connected; and
a game information management unit configured to provide a reward item to the user when the user clears the first point and determine whether to provide a service of the second point according to a condition of the reward item if the user enters the second point.

9. The device for providing a game service of claim 8 wherein a learning item in said one or more first points are a precondition for a learning item in said second first point, and the reward item comprises a plurality of first key item which corresponds to one or more first points, and the game information management unit determines whether a key condition is satisfied based on whether all key items are acquired.

10. The device for providing a game service of claim 9 wherein the game information management unit provides other key related information if the key condition is not satisfied.

11. The device for providing a game service of claim 8 wherein the game information management unit generates game information for each point of the lesson path; and generates a base point which corresponds to the learning goal, and wherein provides the current game achievement state information related to said user and an alternative paths and learning items when said user enters the base point.

12. The device for providing a game service of claim 8 further comprising a knowledge information management unit which collects learning information including text corpus related to the learning item from the World Wide Web; generates relationship information between the text corpus and learning item; and performs a layering processing of the learning information based on said relationship information, and wherein the visual knowledge map-constructing unit constructs the visual knowledge map in which a distance and a coordinate for each learning item are determined according to said relationship information using said layered learning information.
